(19) United States
(12) Patent Application Publication
(10) Pub. No.: US 2008/0081236 A1
(43) Pub. Date: Apr. 3, 2008

(54) ELECTRIC POWER SUPPLY SYSTEM OF FUEL CELL

(75) Inventor: Masaaki Kanashiki, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/846,754

(22) Filed: Aug. 29, 2007

(30) Foreign Application Priority Data
Oct. 3, 2006 (JP) 2006-271469

(51) Int. Cl. H01M 8/04

(52) U.S. Cl. 429/23; 429/12

(57) ABSTRACT

In order to provide an electric power supply system of a fuel cell capable of making the system smaller and lightweight and counteracting the instantaneous fluctuation of a load current, the electric power supply system of a fuel cell includes: a plurality of fuel cell blocks each having at least one fuel cell outputting a voltage lower than a necessary voltage for a load, and an insulating DC-DC converter connected to each of the at least one fuel cell; a unit for sequentially driving each insulating DC-DC converter in the plurality of fuel cell block; a connection unit for circularly connecting each fuel cell block such that the necessary voltage can be obtained by superposing an output voltage obtained by the insulating DC-DC converter in one fuel cell block by driving of the sequential drive unit on an output voltage of a fuel cell stack in other fuel cell blocks to obtain a desired voltage; and an output unit combining and outputting the voltage obtained by the superposing.

### BACKGROUND OF THE INVENTION

1. Field of the Invention

The present invention relates to an electric power supply system of a fuel cell, and more specifically to an electric power supply system of a fuel cell for supplying electric power generated by the fuel cell to a load.

2. Description of the Related Art

Recently, there has been the problem that the greenhouse effect due to increased carbon dioxide rapidly proceeds with global warning, and a fuel cell has attracted attention as a new energy source.

Most of all, since a polymer electrolyte fuel cell operates at a lower temperature as compared with fuel cells in other methods, it is the most promising power source of an electric vehicle and portable electronic apparatus, and its practical use is strongly demanded.

The characteristic of the polymer electrolyte fuel cell is that the theoretical electromotive voltage is about 1.23 V, a voltage gradually drops as a load current increases, and it suddenly drops when a certain current value is exceeded.

A voltage drops with a load current increasing, and the reduction of the electromotive force is called polarization. The polarization is classified into the following three types (1) to (3).

(1) Activation polarization caused by necessary energy for activation of a fuel in an electrode.

(2) Ohmic polarization caused by the resistance of elements that form a fuel cell, the contact resistance between the elements.

(3) Diffusion polarization caused by the limit of the supply speed of the reactive substance, and the inhibition of the supply of a reactive substance by a reaction product in the electrode.

In the above-mentioned polarization, the diffusion polarization caused by the supplement of a reactive substance in electrode, the removal of a product, etc. indicates the electromotive force suddenly reduced when a current value exceeds a predetermined value.

Thus, described below with reference to FIG. 5 is that the reduction of the electromotive force is mainly caused by the diffusion polarization due to the removal of a product etc.

FIG. 5 is a graph showing the load characteristic of a general polymer electrolyte fuel cell unit.

In the graph shown in FIG. 5, the vertical axis indicates the voltage and electric power, and the horizontal axis indicates the load current per unit area of a fuel cell unit.

The static (direct current) load characteristic of a solid polymer electrolyte fuel cell is indicated by A illustrated in FIG. 5. Assuming that the actually used voltage is 0.5 V, the load current per unit area is about 0.4 A/cm².

The product of the voltage and the current, that is, the electric power A′ is expressed by the broken line.

Furthermore, the dynamic load (pulse load) characteristic is expressed by B. Assuming that the actual voltage is 0.5 V, the load current per unit area is about 0.9 A/cm². The product of the voltage and the current, that is, the electric power B′ is expressed by the broken line.

In the cases of a static (direct current) load and a dynamic (pulse) load, the electric power taken out of the fuel cell is expressed by A′ and B′ respectively, and reaches the maximum when the load current corresponding to the peak of each curve. The point at which the maximum power of the fuel cell can be taken out is referred to as a maximum output point.

The maximum output point of a fuel cell largely depends on which is taken out, a static load current or a dynamic load current as clearly illustrated in FIG. 5.

This is mainly caused by the diffusion polarization due to the restriction of the supply speed of a reactive substance in the polarization, and the inhibition of the supply of a reactive substance by a reaction product.

Described below next is the cause of deterioration of the load characteristic of a fuel cell stack made by stacking a plurality of fuel cells for the load characteristic of one fuel cell.

FIG. 6 is a graph of the load characteristic of a polymer electrolyte fuel cell stack according to the conventional technology.

In FIG. 6, the vertical axis indicates the voltage, and the horizontal axis indicates the load current per unit area of a fuel cell unit.

In FIG. 6, the static load characteristic of a fuel cell unit is indicated by C, and the static load characteristic of a fuel cell stack is indicated by D. For comparison, the output voltage D of the fuel cell stack is an output voltage per fuel cell unit which is obtained by dividing the output voltage of the fuel cell stack by the number of constituting fuel cell units. As clearly shown by the graph, when a plurality of fuel cell units are stacked and form a fuel cell stack, the output voltage per fuel cell unit is reduced.

This is because equally supplying the fuel, that is, hydrogen and oxygen, to all fuel cell units constituting the fuel cell stack is difficult.

In a general fuel cell stack, the unevenness in density of a hydrogen gas and an oxygen gas, the unevenness in temperature of a stacked fuel cell units, and the unevenness in internally generated water contents make differences in generation capability of various fuel cell units.

Thus, with reference to the load characteristic of a fuel cell unit, the load characteristic per fuel cell unit of a fuel cell stack is normally reduced.

When the polymer electrolyte fuel cell having the above-mentioned characteristic is used for an electric vehicle, the output about several tens kW of the loaded fuel cell is required, and the voltage for driving a motor is about 200 to 400 V.

With reference to the necessary voltage of 200 V, for example, to drive a motor, if the generation voltage of the fuel cell when a load current is passed is 0.5 V, it is necessary to stack as many as 400 fuel cell units to constitute a fuel cell stack so that a desired voltage can be obtained.

As described, since it is difficult to provide 400 fuel cell units and reserve a stable operation, for example, ten fuel cell stacks each including 40 fuel cell units are connected in series to obtain and use a desired voltage.

Furthermore, when the electric power obtained by a fuel cell is used with a commercial power for home use, it is necessary to keep the matching voltage and frequency between the power generated by the fuel cell and the commercial power for home use.

Therefore, a voltage and a frequency are converted using a DC-AC inverter.

Also in this case, a fuel cell stack of fuel cell units is used.

Thus, with the fuel cell stack, there is the problem in cost and stability of operations because a large number of fuel cell units are stacked and used.

To avoid the problem, there have conventionally been some propositions.

For example, the Japanese Patent Application Laid-Open No. 2000-188120 proposes a high-power fuel cell system capable of suppressing the unevenness of voltage between fuel cell units.

In the fuel cell system, the fuel cell stack forming the fuel cell system is calculated as having the number of fuel cell units smaller than the number obtained by dividing the necessary voltage of an external load by the output voltage of the fuel cell.

The voltage is converted using a DC-DC converter or a DC-AC inverter.

Furthermore, the Japanese Patent Application Laid-Open No. 2004-235094 proposes a fuel cell system capable of suppressing the reduction of the efficiency of the entire system by using a low output voltage stack having a smaller number of stacks of fuel cells.

In this system, the number of cells of the low output voltage fuel cell stack constituting a fuel cell system is less than the number of cell units of the high output voltage fuel cell stack, and the area of the fuel cell units is set as large as the total area of the high output voltage fuel cell stack. To increase the capacity, the low voltage fuel cell stacks are connected in parallel, a low output voltage fuel cell stack having a smaller number of stacks of fuel cell units is used, and a resonant DC-DC converter is used to enhance the efficiency of the above-mentioned DC-DC converter.

Furthermore, as described above, the polymer electrolyte fuel cell is the most promising as a portable power supply to portable electronic equipment, and the technical development has been pursued to improve the performance.

The operation voltage of portable electronic equipment is much lower than the voltage of the commercial power for electric vehicle and home use, and the voltage is some DC volts.

When a load current of portable electronic equipment is constant, a fuel cell of a power capacity corresponding to the load current can be used.

However, the portable electronic equipment can be, for example, equipment whose load current instantaneously and largely fluctuates when the mirror operates up and down as a single-lens reflex digital camera, or equipment whose load current instantaneously and largely fluctuates when a motor is activated as a camcorder.

The fluctuation of the load currents requires an instantaneous load current twice as much as a stationary load current, and the time is several mS to several hundred mS.

For equipment whose load current largely fluctuates, it is necessary to keep fuel cells capable of supplying constantly large load current and therefore reserve a large cell capacity, thereby unpreferably raising the cost and increasing the size of the fuel cells.

Therefore, in the conventional technology, the following method has been adopted without a fuel cell to counteract the reduction of a power supply voltage due to an instantaneously increasing load current of electronic equipment.

That is, using a capacitor of a large capacity, a small secondary cell, etc. parallel to the power supply source of the electronic equipment, electric power is supplied from the capacitor or the secondary cell when the power supply voltage is reduced due to an increased instantaneous load current, thereby counteracting the reduction of the power supply voltage.

However, in the technology of the Japanese Patent Application Laid-Open No. 2000-188120, it is necessary to have a large fuel cell to build a fuel cell system to prevent the reduction of a voltage below the necessary value for the operation of equipment whose load current suddenly changes.

Therefore, the cost soars, and when the technology is applied to the electronic equipment, etc., there arises a problem that the implementation and mounting areas of the fuel cell system are enlarged.

In addition, in the technology of the Japanese Patent Application Laid-Open No. 2004-235094, the smaller number of stacks requires the counteraction against the output reduction, and it is therefore necessary to have an enlarged area of fuel cells proportional to the step-up rate of the DC-DC converter.

Therefore, further improvement has been demanded for a smaller and lightweight fuel cell.

Additionally, although the above-mentioned methods are effective when there is no change in load current, there is the possibility that a voltage drops when the load current largely changes.

Thus, the fuel cells according to the technology described in the Japanese Patent Application Laid-Open Nos. 2000-188120 and 2004-235094 require further improvement to be used as power supply to portable electronic equipment whose load current largely fluctuates.

### SUMMARY OF THE INVENTION

The present invention is oriented to an electric power supply system of a fuel cell, which is capable of counteracting the instantaneous fluctuation of a load current and being designed as a smaller and lightweight system.

The present invention provides an electric power supply system of a fuel cell having the following configuration. The electric power supply system of a fuel cell according to the present invention supplies electric power generated by a fuel cell to a load, and includes: a plurality of fuel cell blocks having at least first and second fuel cell blocks each including at least one fuel cell outputting a voltage lower than a necessary voltage, and an insulating DC-DC converter connected to each of the at least one fuel cell; a sequential drive unit for sequentially driving each insulating DC-DC converter in the plurality of fuel cell block including the first and second fuel cell blocks; a connection unit for circularly connecting each fuel cell block such that the necessary voltage can be obtained by superposing an output voltage obtained by the insulating DC-DC converter in the first fuel cell block by driving of the sequential drive unit on an output voltage of a plurality of fuel cell blocks including the second fuel cell block; and an output unit combining and outputting the voltage obtained by the superposing. In the present invention, the connection unit includes, for example, a connection wiring, but the connection unit is not limited to the connection wiring. The output unit includes, for example, an output wiring, but the output unit is not limited to the output wiring.

In the electric power supply system of a fuel cell according to the present invention, the sequential drive unit for sequentially driving each insulating DC-DC converter sequentially and equally drives each fuel cell block for a time of 1/(number of the plurality of fuel cell blocks) or less, and the driving is performed such that the electric power is not supplied in the stop time while leveling the time of operating each fuel cell block.

In the electric power supply system of a fuel cell according to the present invention, the fuel cell is formed of a fuel cell stack including a single fuel cell unit or a plurality of fuel cell units.

In the electric power supply system according to the present invention, the output unit for outputting the voltage is provided with an output voltage detection circuit for detecting an output voltage, and the sequential drive unit for sequentially driving each insulating DC-DC converter is provided with a pulse width modulation circuit for varying a pulse width.

The electronic apparatus according to the present invention is provided with an electric power supply system of any fuel cell described above.

The present invention can counteract the instantaneous fluctuation of a load current, and can be realized as a smaller and lightweight system.

Further features of the present invention will become apparent from the following description of exemplary embodiments with reference to the attached drawings.

### BRIEF DESCRIPTION OF THE DRAWINGS

FIG. 1 is an explanatory view of the electric power supply system of a fuel cell provided with a voltage conversion apparatus for supplying the electric power generated by a fuel cell to a load according to a mode for embodying the present invention.

FIG. 2 is an explanatory view of the operation in the driving time of sequential drive by the insulating DC-DC converter in the electric power supply system of a fuel cell according to a mode for embodying the present invention.

FIG. 3 is an explanatory view illustrating the relationship of the output voltage by the insulating DC-DC converter in the electric power supply system of a fuel cell according to a mode for embodying the present invention.

FIG. 4 is an explanatory view of the operation of the voltage continuously obtained by superposition of the insulating DC-DC converter in the electric power supply system of a fuel cell according to a mode for embodying the present invention.

FIG. 5 is an explanatory view of an example of the static characteristic and the dynamic characteristic of a fuel cell according to the conventional technology.

FIG. 6 is an explanatory view of an example of a load characteristic of a fuel cell stack obtained by stacking fuel cells of the polymer electrolyte fuel cell according to the conventional technology.

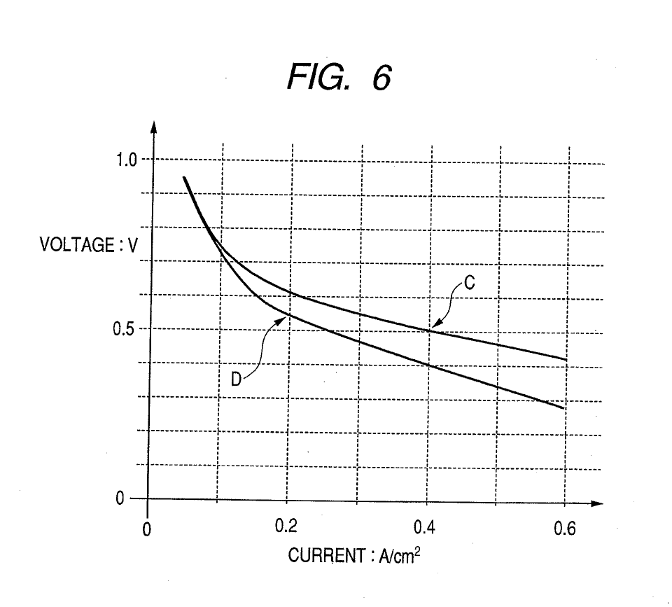

### DESCRIPTION OF THE EMBODIMENTS

Described below is a mode for embodying the present invention.

In the electric power supply system of a fuel cell for supplying to a load the electric power generated by a fuel cell according to a mode for embodying the present invention, a plurality of fuel cell stacks having a lower output voltage than a desired voltage and a plurality of fuel cell blocks configured by an insulating DC-DC converter connected to fuel cell stacks and sequentially driven are provided and connected circularly in sequence so as to obtain a desired voltage by superposing. A voltage obtained by the insulating DC-DC converter connected to the fuel cell stack and sequentially driven on the output voltage of the fuel cell stack of another fuel cell block, and the desired voltage obtained by superposing is combined and output.

With the above-mentioned configuration, since the method of converting a voltage into a desired voltage is performed efficiently, and the output voltage can be a direct current, the capacity of a leveling inductor and a leveling capacitor can be reduced, thereby realizing a smaller and lightweight apparatus.

Next, a mode for embodying the present invention is described further in detail with reference to the attached drawings.

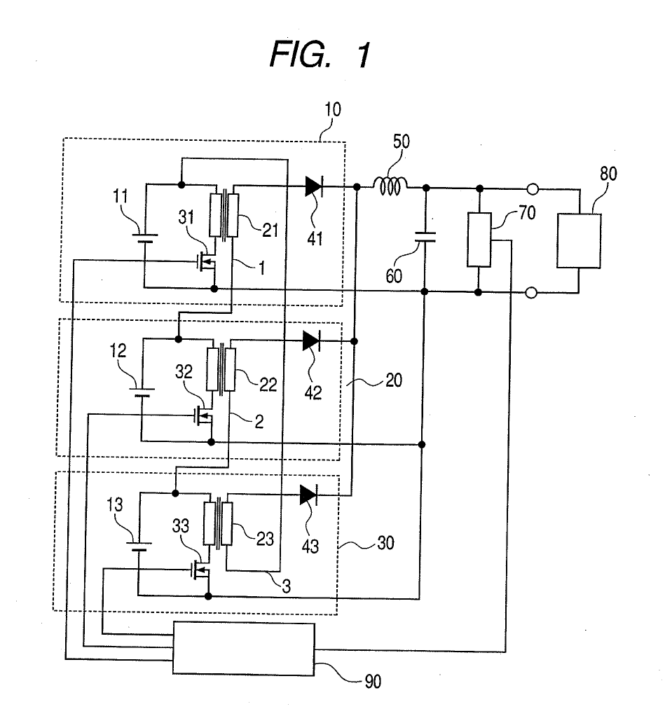

FIG. 1 is an explanatory view of an electric power supply system of a fuel cell provided with a voltage conversion apparatus for supplying electric power generated by the fuel cell to a load according to the mode for embodying the present invention.

In FIG. 1, fuel cell stacks 11, 12 and 13 output a voltage lower than a voltage supplied to a load.

In this mode for embodying the present invention, the fuel cell stacks 11, 12 and 13 have a configuration including fuel cell stacks as units for outputting a voltage lower than a voltage supplied to a load, but the present invention is not limited to this configuration.

For example, a unit for outputting a voltage lower than a necessary desired voltage, the unit can be a fuel cell unit.

Electric power transformers 21, 22 and 23 constitutes an insulating DC-DC converter having a turn ratio obtained by a voltage generated by a fuel cell stack and a voltage supplied to a load.

Switching elements 31, 32, and 33 configure an insulating DC-DC converter. A main component is a MOS-FET having low on-resistance between a drain and a source.

Rectifier elements 41, 42, and 43 use a diode indicating lower voltage drop in the forward direction, and recently use a MOS-FET having low on-resistance between a drain and a source.

The system also includes a leveling inductor 50, a leveling capacitor 60, an output voltage detection element 70, electronic equipment 80 as a load, and a sequential drive circuit 90 for sequentially driving a switching element configuring an insulating DC-DC converter.

The system also includes a first fuel cell block 10, a second fuel cell block 20, and a third fuel cell block 30.

These fuel cell blocks are connected to the fuel cell stacks 11, 12, and 13, and configure a sequentially driven insulating DC-DC converter.

In the mode for embodying the present invention, the number of fuel cell blocks is 3, but the present invention is not limited to this configuration, and can be configured by two or more fuel cell blocks (when two blocks are used, the pulse width can be any value but ½).

In the description of the mode for embodying the present invention, there are three blocks illustrated in FIG. 1, that is, the first fuel cell block 10, the second fuel cell block 20, and the third fuel cell block 30.

Described below is the operation of the electric power supply system by a fuel cell according to the present mode for embodying the invention. The sequential drive circuit 90 sequentially drives the switching element 31 of the insulating DC-DC converter configured by the electric power transformer 21, the switching element 31, and the rectifier element 41 connected to the fuel cell stack 11 in the first fuel cell block 10 for a ⅓ or less time. It is desired that the pulse width in the driving time at this time is several ten nS to several ten μS.

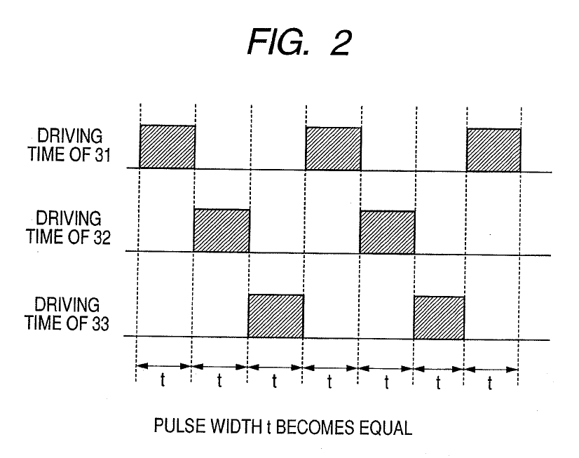

FIG. 2 illustrates the state in a sequential driving time.

In this example, there occurs at the secondary side of the electric power transformer 21 during the driving time an output voltage obtained by multiplying the voltage of the fuel cell stack 11 by the turn ratio of the primary side and the secondary side of the electric power transformer 21. The rectifier element 41 rectifies the voltage generated at the secondary side of the electric power transformer 21.

The output voltage obtained by the insulating DC-DC converter configured by the electric power transformer 21, the switching element 31, and the rectifier element 41 connected to the fuel cell stack 11 is superposed on the output voltage of the fuel cell stack 12 in the second fuel cell block 20.

The thus obtained output voltage is the voltage obtained through a connection wiring 1 by adding the output voltage which is obtained by multiplying the voltage of the fuel cell stack 11 in the first fuel cell block 10 by the turn ratio at the primary side and the secondary side of the electric power transformer 21 to the output voltage of the fuel cell stack 12 in the second fuel cell block 20. The thus obtained voltage is designed to become the necessary voltage as desired.

In a manner similar to the above, the obtained output voltage is the voltage obtained through a connection wiring 2 by adding the output voltage which is obtained by multiplying the voltage of the fuel cell stack 12 in the second fuel cell block 20 by the turn ratio at the primary side and the secondary side of the electric power transformer 22 to the output voltage of the fuel cell stack 13 in the third fuel cell block 30.

Further, in a manner similar to the above, the obtained output voltage is the voltage obtained through a connection wiring 3 by adding the output voltage which is obtained by multiplying the voltage of the fuel cell stack 13 in the third fuel cell block 30 by the turn ratio at the primary side and the secondary side of the electric power transformer 23 to the output voltage of the fuel cell stack 11 in the first fuel cell block 10.

As described above, the respective fuel cell blocks of the present invention are circularly connected. In FIG. 2, the waveform is obtained by the sequential drive for a ⅓ time. However, when there is a low load current, it is desired that the sequential drive is performed for less than ⅓ time. When the load current reaches the maximum, it is desired that the sequential drive is performed for a ⅓ time.

The reason why the output voltage obtained by the insulating DC-DC converter connected to the fuel cell stack 11 of the first fuel cell block 10 is superposed on the output voltage of the fuel cell stack 12 in the second fuel cell block 20 is described below.

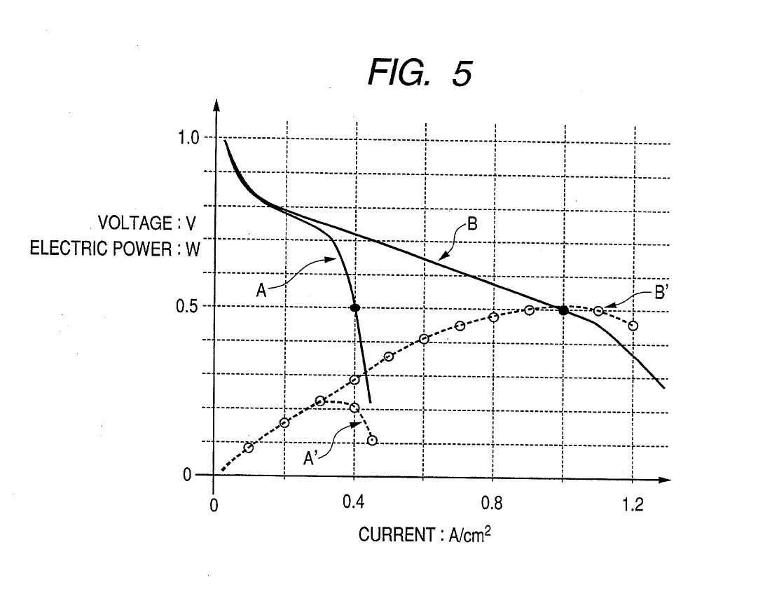

As described below with reference to FIG. 5, when the higher current is taken from a fuel cell, a larger voltage drop occurs. When the insulating DC-DC converter configured by the electric power transformer 21, the switching element 31, and the rectifier element 41 is driven, the output voltage of the fuel cell stack 11 in the first fuel cell block 10 drops by the above-mentioned polarization.

At this time, a voltage of a stable and sufficient voltage is guaranteed for the fuel cell stack 12 in the second fuel cell block 20 because the electric power supply is stopped and the influence of the diffusion polarization is moderated in the stop time.

Thus, the superposition on the output voltage of the fuel cell stack 12 in the second fuel cell block 20 guarantees a necessary, stable, and desired voltage.

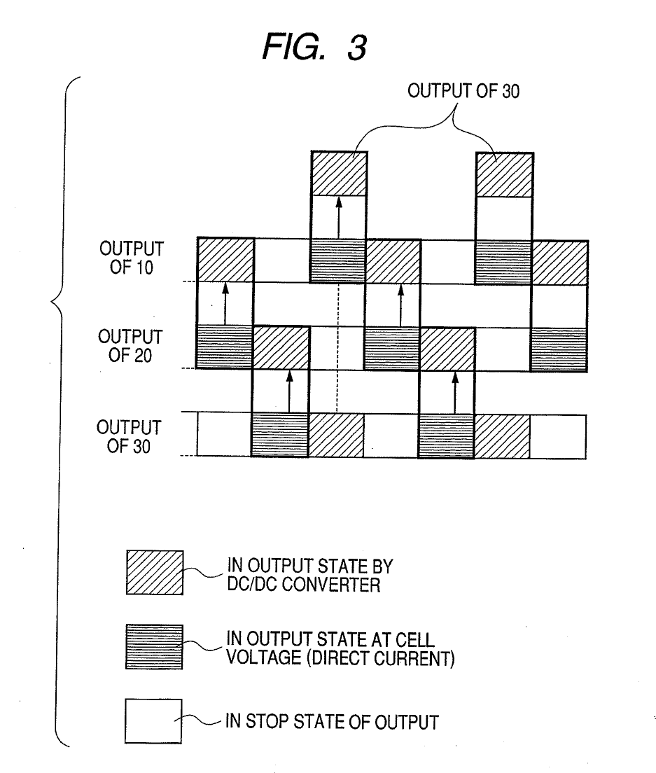

FIG. 3 illustrates the relationship of the output voltage.

With the above-mentioned unit, the method for obtaining a necessary desired voltage is a method more efficient than obtaining a necessary desired voltage directly using an insulating DC-DC converter from a fuel cell stack for the following reason.

The efficiency of a DC-DC converter is generally 80 to 90%.

In the above-mentioned method, the operation of the fuel cell stack 12 in the superposed second fuel cell block 20 is a direct current operation of supplying electric power directly without using a converter.

Therefore, no loss is caused by the efficiency of the DC-DC converter relating to the electric power in this block, thereby improving the total efficiency of the electric power obtained by the superposition.

By sequentially driving the first fuel cell block 10, the second fuel cell block 20, and the third fuel cell block 30 illustrated in FIG. 1 in the above-mentioned operation, the voltage obtained by the superposition can be obtained continuously and stably.

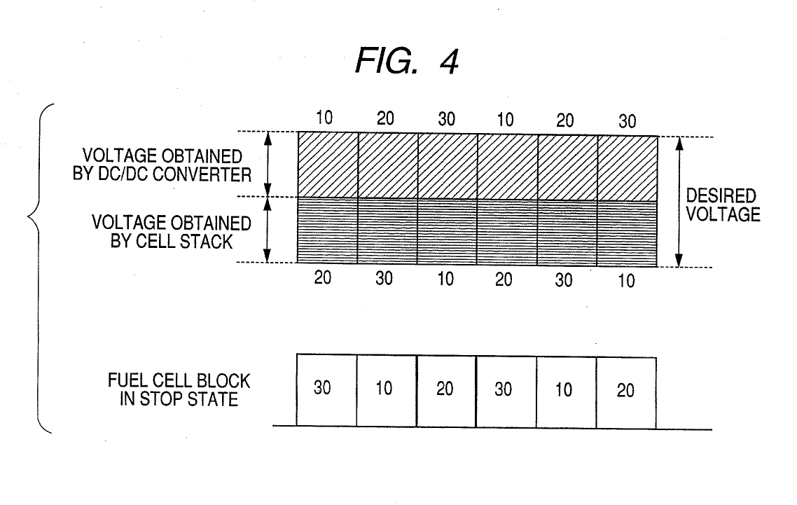

FIG. 4 illustrates the status of the voltage continuously obtained by the superposition.

The thus obtained voltage is leveled by the leveling inductor 50 and the leveling capacitor 60, and supplied to the electronic equipment 80 as a load.

As illustrated in FIG. 4, a voltage obtained by combination is a constant pulse voltage, and/or substantially a direct current voltage.

In the above-mentioned mode for embodying the present invention, each fuel cell block can be equally driven to level the operation time of each fuel cell block.

Concurrently, by setting a stop time in which no electric power is supplied, a reactive substance in the electrode is supplied, thereby reducing the influence of the restrictions on the supply speed of a reactive substance in the electrode that is generated when a high load current is supplied and the diffusion polarization caused by the inhibition on the supply of a reactive substance by a reaction product.

Thus, the present invention can counteract the instantaneous fluctuation of a load current.

In the insulating DC-DC converter according to the above-mentioned mode for embodying the present invention, it is desired that the efficiency of the DC-DC converter can be improved with a full-bridge configuration having a plurality of switching elements.

To obtain a furthermore desired necessary voltage, the output voltage detection element 70 can be provided, and a well-known feedback circuit such as a pulse width modulation circuit can be provided in the sequential drive circuit 90.

As described above, the electric power supply system of a fuel cell having a voltage conversion apparatus for supplying electric power generated by the fuel cell according to the present mode for embodying the invention can provide a small, high-efficiency, and low-price fuel cell generation system capable of counteracting the instantaneous fluctuation of a load current.

Furthermore, the electric power source of electronic equipment can be provided, and especially the present invention can provide a useful fuel cell power generation system as a power source of portable electronic equipment whose load current greatly and instantaneously changes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-271469, filed Oct. 3, 2006, which is hereby incorporated by reference herein in its entirety.

What is claimed is:

1. An electric power supply system of a fuel cell for supplying electric power generated by a fuel cell to a load, comprising:
a plurality of fuel cell blocks having at least first and second fuel cell blocks each including at least one fuel cell outputting a voltage lower than a necessary voltage, and an insulating DC-DC converter connected to each of the at least one fuel cell;
a sequential drive unit for sequentially driving each insulating DC-DC converter in the plurality of fuel cell block including the first and second fuel cell blocks;
a connection unit for circularly connecting each fuel cell block such that the necessary voltage can be obtained by superposing an output voltage obtained by the insulating DC-DC converter in the first fuel cell block by driving of the sequential drive unit on an output voltage of a plurality of fuel cell blocks including the second fuel cell block; and
an output unit combining and outputting the voltage obtained by the superposing.

2. The electric power supply system of a fuel cell according to claim 1, wherein the sequential drive unit for sequentially driving each insulating DC-DC converter sequentially and equally drives each fuel cell block for a time of 1/(number of the plurality of fuel cell blocks) or less; and the driving is performed such that the electric power is not supplied in the stop time while leveling the time of operating each fuel cell block.

3. The electric power supply system of a fuel cell according to claim 1, wherein the fuel cell is formed of a fuel cell stack including a single fuel cell unit or a plurality of fuel cell units.

4. The electric power supply system of a fuel cell according to claim 1, wherein the output unit for outputting the voltage is provided with an output voltage detection circuit for detecting an output voltage; and the sequential drive unit for sequentially driving each insulating DC-DC converter is provided with a pulse width modulation circuit for varying a pulse width.

5. An electronic apparatus comprising an electric power supply system of the fuel cell according to claim 1.
